(19) United States
(12) Patent Application Publication
(10) Pub. No.: US 2002/0065847 A1
(43) Pub. Date: May 30, 2002

(54) Form processing system, management system of form identification dictionary, form processing terminal and distribution mehtod of form identification dictionary

(75) Inventors: Naohiro Furukawa, Hachioji (JP); Hiroshi Sako, Shiki (JP); Hiromichi Fujisawa, Tokorozawa (JP)

Correspondence Address: Stanley P. Fisher, Reed Smith Hazel & Thomas LLP, Suite 1400, 3110 Fairview Park Drive, Falls Church, VA, 22042, US

(73) Assignee: Hitachi, Ltd.

(21) Appl. No.: 09/805,884

(22) Filed: Mar. 15, 2001

(30) Foreign Application Priority Data
Nov. 27, 2000 (JP) 2000-359598

(51) Int. Cl. G06F 17/30; G06F 17/21

(52) U.S. Cl. 707/505; 707/3

(57) ABSTRACT

When a form processing terminal fails to identify a form, image information of the identification-failed form is transmitted to a work center. A manager of form identification dictionary of the work center analyzes the cause(s) of the identification failure, and updates the form identification dictionary while allowing the form processing system to operate. Update information is transmitted to the form processing terminal. The form processing terminal can also transmit to the work center information, which characterizes the form type, together with the image of the identification-failed form. The use of the updated information of the form by the form processing terminal is recorded in a user action log for fee charging purpose.

### BACKGROUND OF THE INVENTION

1. Field of the Invention

The present invention relates generally to a form processing system, a management system of form identification dictionary, a form processing terminal, and a distribution method of form identification dictionary. More particularly, the present invention is related to a form processing system for identifying the types (species) of forms inputted to the system to read information such as amount, payer name or the like written on the form, a management system of form identification dictionary and a form processing terminal which constitute parts of the management system, and a distribution method of form identification dictionary for performing the distribution of the form type identification information between the form processing terminal and the management system of form identification dictionary.

2. Description of the Related Art

The form processing system is a system which is arranged to read out an image of a form such as a payment slip, a tax bill or the like by means of an optical scanner, whereon information such as amount of fee, payer name and so forth written on the form is fetched from the image data to thereby perform processing as required. In general, this system is equipped with the form identification function for identifying the type of the form as inputted, and the form read function for reading the subscriber name, the amount of money and so forth entered in the form.

In order to realize the form identification function, form identification information is demanded which serves as knowledge useful for the identification of the form type. As the form identification information, there may be mentioned, for example, such information as the size or dimension of form sheet, information about ruled lines/frames printed on the form, character strings representing the title of the form, etc. For realizing the form identification function with high accuracy and reliability, the method of creating the form identification information plays an important role.

As the conventional technique concerning the form identification information creating method, the technique described in JP-A-7-152856 is known, for example. According to this technique, an operator designates a useful fragmental area of a form by means of a mouse when the form is identified.

As another conventional technique directed to the form identification information creating method, the technique disclosed in JP-A-11-184965 is known, for example. According to this technique, it is contemplated to make it possible to create easily a handy form dictionary by extracting automatically from a form image the appropriate constituent features thereof such as character patterns satisfying imposed requirements.

As the conventional technique directed to the management of the form identification dictionary in which the form identification information is described, the technique described in JP-A-9-73502 is known, for example. According to this technique, plural form classifying apparatuses are interconnected via a network. Here, only one of the form classifying apparatuses is equipped with a form identification dictionary, the contents of which are distributed to the other form classifying apparatuses via the network.

As the conventional technique directed to the form processing system, those disclosed in JP-A-7-114616 and JP-A-11-167603 are known, for example. These conventional techniques are concerned with the form identification and the form reading performed via a network.

All of the conventional techniques enumerated above require that the form identification dictionary be created by collecting all the form types in advance. Consequently, in practical applications, the number of the form types which can be disposed of with these conventional techniques is at most on the order of several tens. In reality, however, there exist several tens of thousands of form types which are handled by the financial institutions in Japan, for example. Thus, an attempt to collect all of these forms at one time will encounter a great difficulty. Besides, the fact that the layouts of these forms are frequently changed (or updated) must be taken into account.

For the reasons mentioned above, all of the conventional techniques have a problem that it is impossible to cope with several tens of thousands of form types.

### SUMMARY OF THE INVENTION

In the light of the state of the conventional techniques, an object of the present invention is to provide a form processing system, a management system of form identification dictionary, a form processing terminal, and a distribution method of form identification dictionary which make it possible to change (or update) the form identification information as occasion demands while ensuring capability of coping with several tens of thousands of form types, and of creating the form identification dictionary.

Another object of the present invention is to provide a form processing system, a management system of form identification dictionary, a form processing terminal, and a distribution method of form identification dictionary which are capable of charging fees for services such as distribution service of the form identification information.

The above objects are achieved by the following form processing system according to the present invention. The form processing system comprises a management system of form identification dictionary including a manager of form identification dictionary for creating and managing a form identification dictionary for identifying the types of forms, and a plurality of form processing terminals, each form processing terminals having a form identification dictionary for identifying a type of a form, and identifying the form to process the form, wherein the management system of form identification dictionary and the plurality of form processing terminals are interconnected via a network. Upon occurrence of failure in identification of the form carried out by the form processing terminal based on its own form identification dictionary, image information of the identification-failed form is transmitted to the management system of form identification dictionary. Then, the management system of form identification dictionary determines analytically which of cases (a), (b) and (c) mentioned below the cause of the identification failure is attributable to:

(a) a case where the form type concerned has not yet been registered in a form identification master dictionary;

(b) a case where although the form type has been registered in the form identification dictionary owned by the terminal, the information of that form identification dictionary is insufficient or inadequate; and

(c) a case where although the form type concerned has been registered in the form identification master dictionary, it has not yet been distributed to the form identification dictionary of the terminal. When the cause of the identification failure can be attributed to case (a) or case (b), the form identification dictionary is changed.

Further, the objects mentioned above are achieved by transmitting together with form image, form identification dictionary creation supporting information such as character strings or coordinates which supports to create the form identification dictionary, when the terminal which fails the identification of the form transmits the form image to be identified.

Furthermore, the objects mentioned above are achieved by recording various service usage history data on a user action log so that a usage fee is calculated on the basis of the data stored in the user action log when the fee is charged.

The above and other objects, features and attendant advantages of the present invention will more easily be understood by reading the following description of the preferred embodiments thereof taken, only by way of example, in conjunction with the accompanying drawings.

### BRIEF DESCRIPTION OF THE DRAWINGS

In the course of the description which follows, reference is made to the drawings, in which:

FIG. 1 is a block diagram showing in general an exemplary configuration of the form processing system according to an embodiment of the present invention;

FIG. 2 is a block diagram showing generally a structure of a form processing terminal together with relations thereof to a user, a financial institution and a work center;

FIG. 3 is a view showing an example of a format of a form;

FIG. 4 is a view for illustrating schematically a structure of form identification information stored in a form identification dictionary;

FIG. 5 is a sequential diagram for illustrating a procedure of form identification dictionary update (or change) processing executed in the form processing system according to an embodiment of the present invention;

FIG. 6 is a flow chart for illustrating a procedure for analytically determining a cause of form identification failure, executed in the work center;

FIG. 7 is a flow chart for illustrating a processing procedure for updating a form identification dictionary, executed in the work center;

FIG. 8 is a flow chart for illustrating a processing procedure for performing the form identification information distribution between the work center and the form processing terminal;

FIG. 9 is a flow chart for illustrating a processing procedure for charging the financial institution with service fee and confirming payment, executed by a manager of system fee in the work center;

FIG. 10 is a flow chart for illustrating a processing procedure for updating the form identification dictionary in case where supporting information for the form identification dictionary creation is text line position information; and

FIG. 11 is a flow chart for illustrating a processing procedure for updating the form identification dictionary in case where the supporting information for the form identification dictionary creation is character string information.

### DESCRIPTION OF THE EMBODIMENTS

Now, referring to the drawings, the present invention will be described in detail in conjunction with embodiments of the form processing system, the management system of form identification dictionary, the form processing terminal, and the distribution method of form identification dictionary according to the present invention. In the following description, like reference characters designate like or corresponding parts throughout the several views.

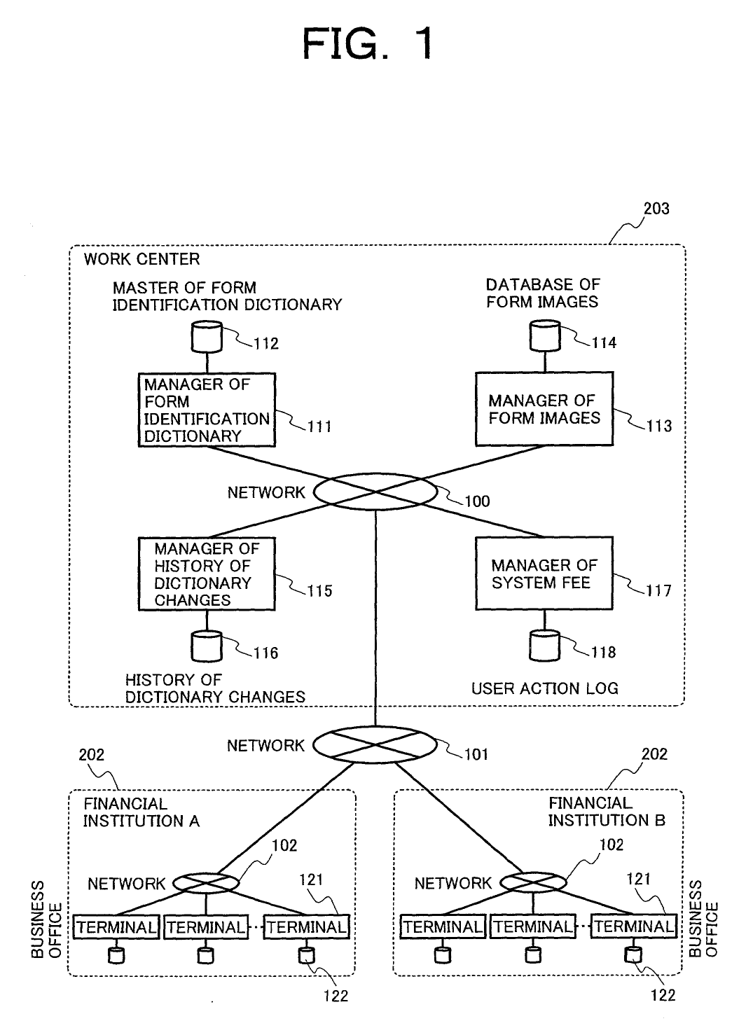

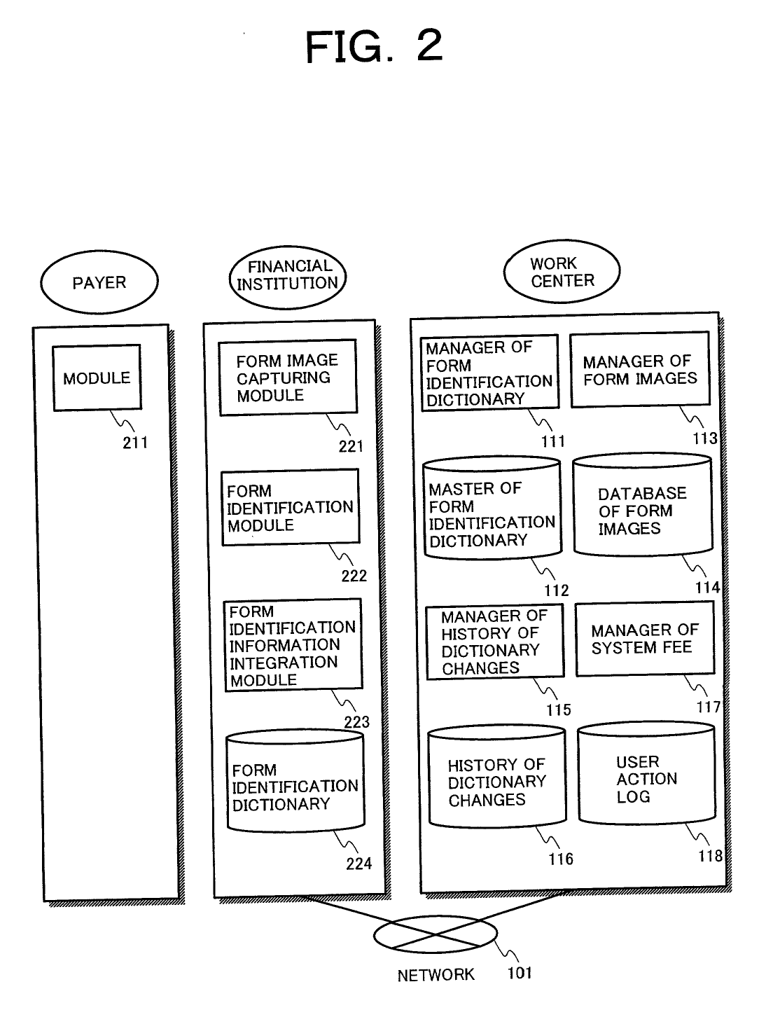

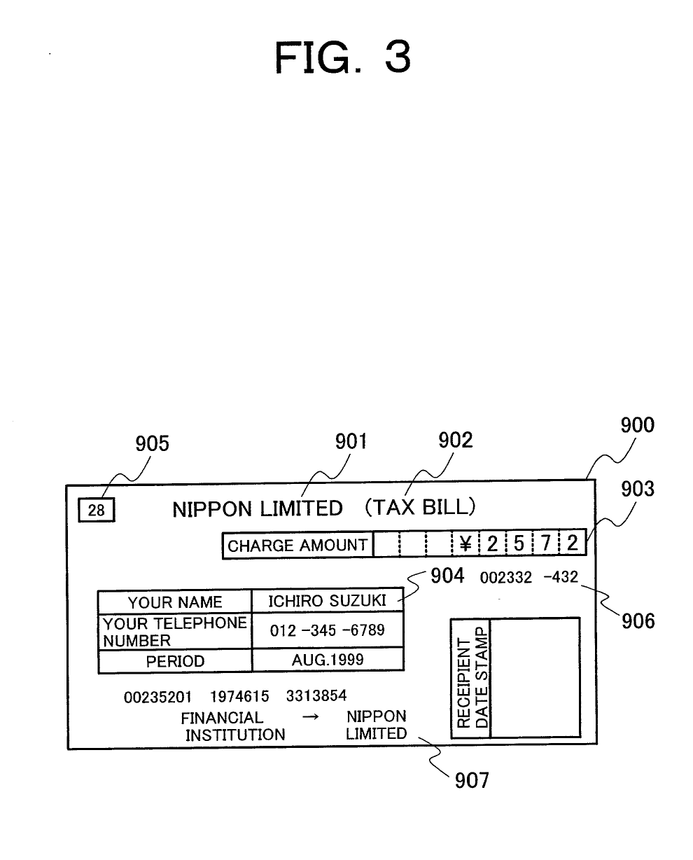

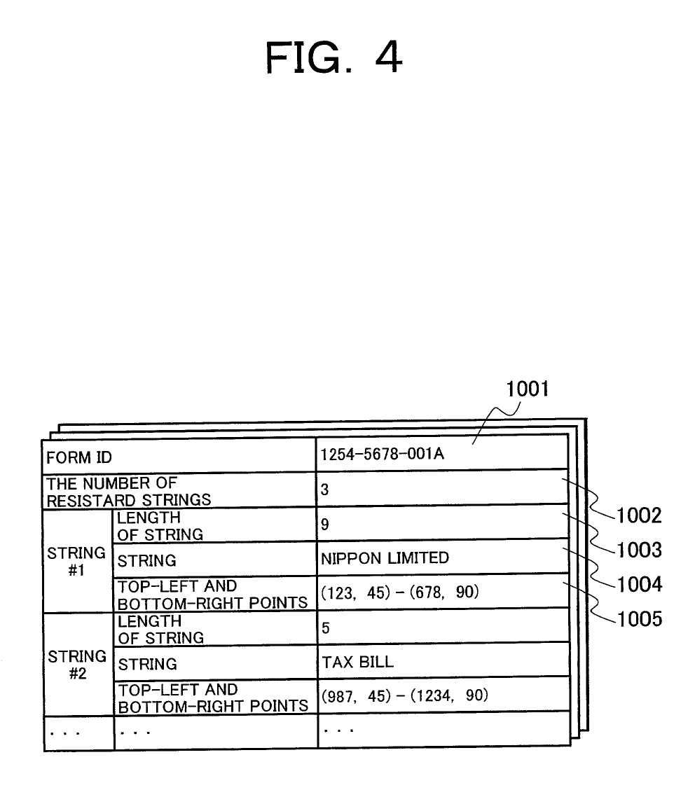

FIG. 1 is a block diagram showing generally a configuration of a form processing system according to an embodiment of the present invention. FIG. 2 is a block diagram showing generally a structure of the form processing terminal together with relations thereof to a user, a financial institution and a work center. FIG. 3 is a view showing an example of a format of a form. FIG. 4 is a view illustrating schematically a structure of form identification information stored in a form identification dictionary. In FIGS. 1 and 2, reference numerals 100-102 denote networks, 111 denotes a manager of form identification dictionary, 112 denotes a master of form identification dictionary, 113 denotes a manager of form images, 114 denotes a database of form images, 115 denotes a manager of history of dictionary changes, 116 denotes a history of dictionary changes, 117 denotes a manager of system fee, numeral 118 denotes a user action log, 121 denotes a form processing terminal, 122 denotes a form identification dictionary installed at the form processing terminal, 201 denotes a payer (a user of a financial institution), 202 denotes a financial institution, 203 denotes a work center, 211 denotes a form, 221 denotes a form image capturing module, 222 denotes a form identification module, 223 denotes a form identification information integration module, and 224 denotes a form identification dictionary.

In the form processing system according to the present embodiment, the work center 203 and the financial institutions 202 are interconnected via the network 101, as can be seen in FIG. 1. The processing of the forms according to the present embodiment is executed through the cooperation of the payer who has a form to be processed, the financial institution 202 which actually processes the form, and the work center 203 which is in charge of managing the form processing system such as change of the form identification dictionary.

The work center 203 has the form identification dictionary 112 in the work center in which all form identification information is stored, and includes the manager of form identification dictionary 111, the master of form images 113, the manager of history of dictionary changes 115, and the manager of system fee 117, as can be seen in FIGS. 1 and 2. The manager of form identification dictionary 111 changes and manages the form identification information. The master of form images 113 stores form images, which are sent from the terminals of the individual financial institutions, in the database of form images 114 to manage these form images. The manager of history of dictionary changes 115 stores the changed information in the history of dictionary changes 116 to manage the change status of the form identification dictionary, and additionally serves the form identification dictionary change information messaging function for messaging the changed form identification information to the relevant financial institution(s) via the network. Finally, the manager of system fee 117 serves for the fee charge function for storing the usage statuses by the financial institutions in the user action log 118 to calculate the system fees on the basis of the usage statuses of the form identification dictionary by the financial institutions and to charge the system fees to the financial institutions. Further, the manager of system fee 117 serves for the fee payment manage function for grasping the payment status of the charged system fees.

The individual managers mentioned above are interconnected via the network 100 such as an intra-office LAN (Local Area Network). The work center 203 itself is connected to the financial institutions 202 via the network 100 and the network 101 such as conventional telephone line, private line, or internet. Incidentally, in case of the form processing system shown in FIG. 1, it is presumed that there are two financial institutions 202. However, this is only for the illustrative purpose. It goes without saying that one or more (plural) financial institutions may be connected to the work center 203.

In order to distinguish the form identification dictionary 112 in the work center 203 from the form identification dictionary 122 in the terminal, the former which the manager of form identification dictionary 111 has is referred to as the master of form identification dictionary 112.

The financial institution 202 is equipped with one or plural form processing terminals 121 installed at one or plural business offices or the like. These business offices are interconnected each other via the network 102 such as the intra-office LAN. On the other hand, the financial institution 202 itself is connected to the work center 203 via the network 100 and the network 101 as mentioned previously. Referring to FIG. 2, the form processing terminal 121 includes the form image capturing module 221 for optically fetching the image of the form, the form identification module 222 for identifying the type of the form, and the form identification information integration module 223 for merging the form identification dictionary 122 in the terminal and the form identification information distributed from the work center 203. The payer 201 of the financial institution has the form 211 and requests to process the form 211 at the terminal 121 of the financial institution.

In FIG. 3, a tax bill is illustrated as an example of the form 211. The illustrated form 211 is composed of character strings 901 and 902 representing the heading or title of the form, charge amount 903, an entry area 904 representing the payer name, a code 905 indicating the form type, which code may be in the form of a bar code, a numeral string or the like, identification information 906 of this form, and a character string 907 indicating the payee name. The form 211 of this example is presumed to be a tax bill. Accordingly, the heading of the form is composed of the character string 901 representing the payee name and the character string 902 representing the tax bill which is the form type. Further, in the entry area 904 representing the payee name, there are written information of “your name” representing the payer, information of “your telephone number”, and information of “period” representing the payment for using during which period. Parenthetically, the code 905 indicative of the form type, the form identification information 906 of this form, and the character string 907 indicative of the payee name may be omitted, as the case may be.

The form identification dictionary contains the form identification information which characterizes the types of the forms. In the form identification dictionary used in the form processing system according to the present embodiment, the character strings printed on the individual forms are extracted as the features of the forms to describe them in the dictionary as the form identification information. FIG. 4 shows an example of such form identification information, which will be described below. Incidentally, other features of the form than those mentioned above may be made use of as the form identification information. Referring to FIG. 4, the form identification information is composed of symbol strings for identifying the form type. The symbol strings includes a form identifier (ID) 1001 unique to each form types, the number of the character strings 1002 characterizing the form type (e.g. in the illustrated example, three character strings are registered), and information 1003-1005 concerning the first to third character strings. The information about the first character string (string #1) will be considered as the representative of the first to third character strings. The information of the first character string is composed of the individual information concerning the string length 1003 of the character string (the illustrated example shows the character string consisting of nine characters), the first character string 1004, and the position information 1005 concerning the location where the first character string is printed. In the illustrated example, the position information is given by the top-left and bottom-right points of rectangle in which the top left corner of the sheet is defined as the origin and the character string is described. The length of the parenthesized character string and the position information are constituted of the length exclusive of the parentheses, and the top-left and bottom-right points of rectangle.

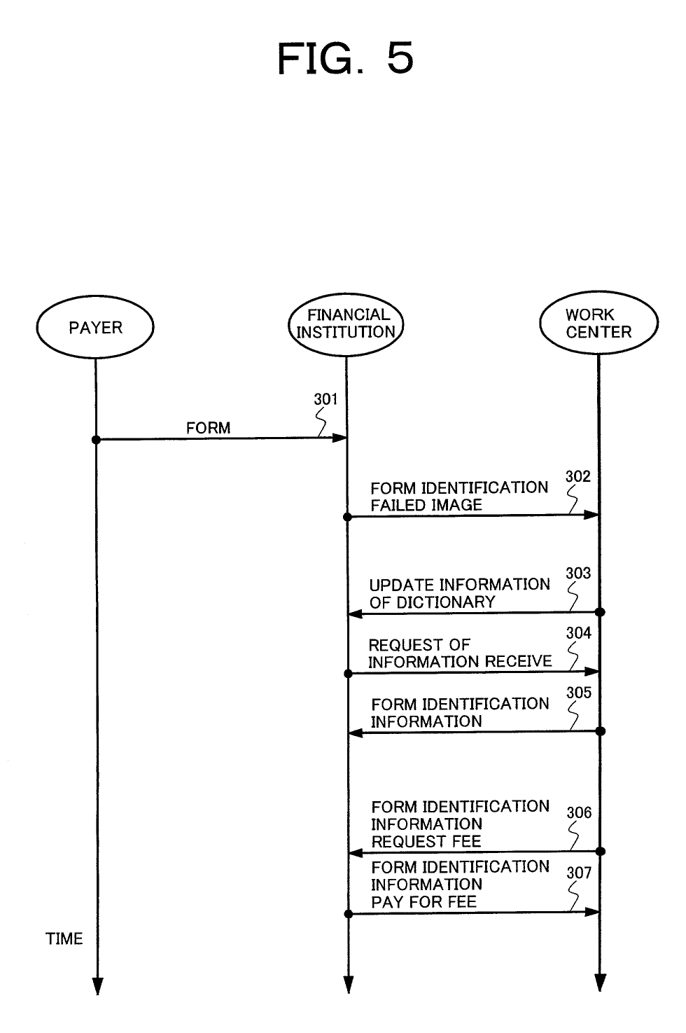

FIG. 5 is a sequential diagram illustrating in concrete a procedure of the form identification dictionary update processing executed in the form processing system according to an embodiment of the present invention, which will be elucidated in detail below.

(1) A payer of the financial institution takes a form to be processed to the financial institution. The financial institution fetches the image of the form by the form processing terminal which constitutes a part of the form processing system, and then executes the form identify processing. When the identification of the form results in failure, the image of the form is then transmitted to the work center (sequences 301, 302).

(2) The work center stores the distributed form image, analyzes the failure cause(s) of the form identification on the basis of the stored form image of the identification-failed form, and updates (or changes) the form identification dictionary in dependence on the analysis results. Concerning the procedure for analyzing the cause(s) of the form identification failure and the procedure for updating the form identification dictionary, description will be made later on. After updating the form identification dictionary, the work center informs the financial institution of the update information of the form identification dictionary (sequence 303).

(3) The financial institution selects the desired information to be distributed, from the received update information, and informs the work center of the desired information. In response, the work center distributes the form identification information as requested to the form processing terminals of the financial institution. The form processing terminal then merges the information being held up to that time point and the distributed new information to thereby create a new form identification dictionary (sequences 304, 305).

(4) The work center records information concerning which form identification information is distributed to the terminal of which financial institution. The statuses of use of the form identification information by the individual financial institutions can be grasped on the basis of these recorded information, and then the fees are calculated and charged to the respective financial institutions. Finally, the work center checks whether or not the fees have been paid by the respective financial institutions (sequences 306, 307).

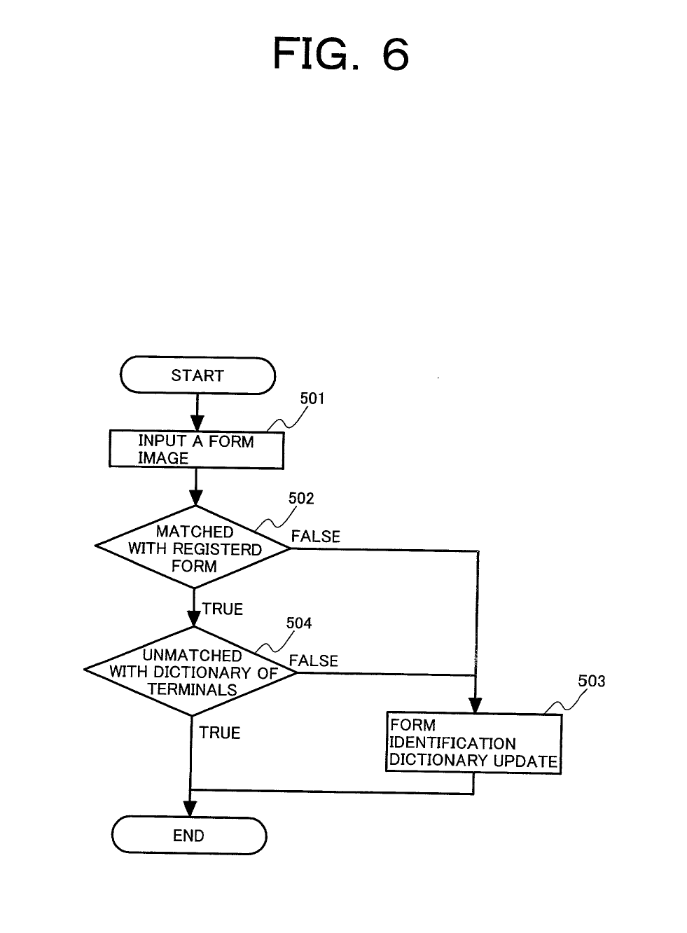

FIG. 6 is a flow chart for illustrating a processing procedure for analyzing the failure cause of the form identification, executed in the work center. The following description is directed to this procedure. The failure analyze processing is executed by the manager of form identification dictionary 111, and analyzes the failure cause(s) of the form identification at the form processing terminal of the financial institution.

As the failure cause of the form identification, there can be conceived the causes mentioned below.

(a) a case where the form type concerned has not yet been registered in the master of form identification dictionary.

(b) a case where although the form type has been registered in the form identification dictionary installed at the terminal, the information contained in the form identification dictionary is insufficient/inadequate.

(c) a case where although the form type has been registered in the master of form identification dictionary, it has not yet been distributed to the form identification dictionary of the terminal. In the form identification failure analyze processing, it is analyzed to which of the cases mentioned above the failure cause of the form identification can be ascribed.

(1) In the first place, the form image sent from the master of form images 113 is inputted, and then it is decided whether or not the form type of the inputted form image is registered in the master of form identification dictionary 112 (steps 501, 502).

(2) When the decision in step 502 results in that the form type of the inputted form image is not registered in the master of form identification dictionary 112, it is then determined that case (a) mentioned above is the failure cause of the form identification. Consequently, there arises the necessity of creating the form identification information for the form type now concerned. Thus, the update processing of the form identification dictionary is executed, and then the processing comes to an end. Incidentally, concerning the update processing of the form identification dictionary will be described later on (step 503).

(3) On the other hand, when it is decided in step 502 that the form type of the inputted form image has already been registered in the master of form identification dictionary, the failure cause of the form identification at the form processing terminal of the financial institution can be ascribed to either case (b) where the form identification failure occurs notwithstanding of the fact that the form type information has been distributed to the dictionary installed in the terminal, or case (c) where the form type information has not yet been distributed to the dictionary installed in the terminal. Under the circumstances, the search processing is performed to check whether or not the form identification information of the form type now concerned has been distributed to the terminal from the user action log 118. When it has been distributed, it can be determined that the failure cause can be attributed to case (b) mentioned above. Accordingly, the update processing of the form identification dictionary in step 503 mentioned previously is executed, and then the processing comes to an end (step 504).

(4) On the contrary, when the decision in step 504 shows that the form identification information has not yet been distributed to the terminal, it is then determined that case (c) mentioned previously can be ascribed to the form identification failure. Then, the processing comes to an end.

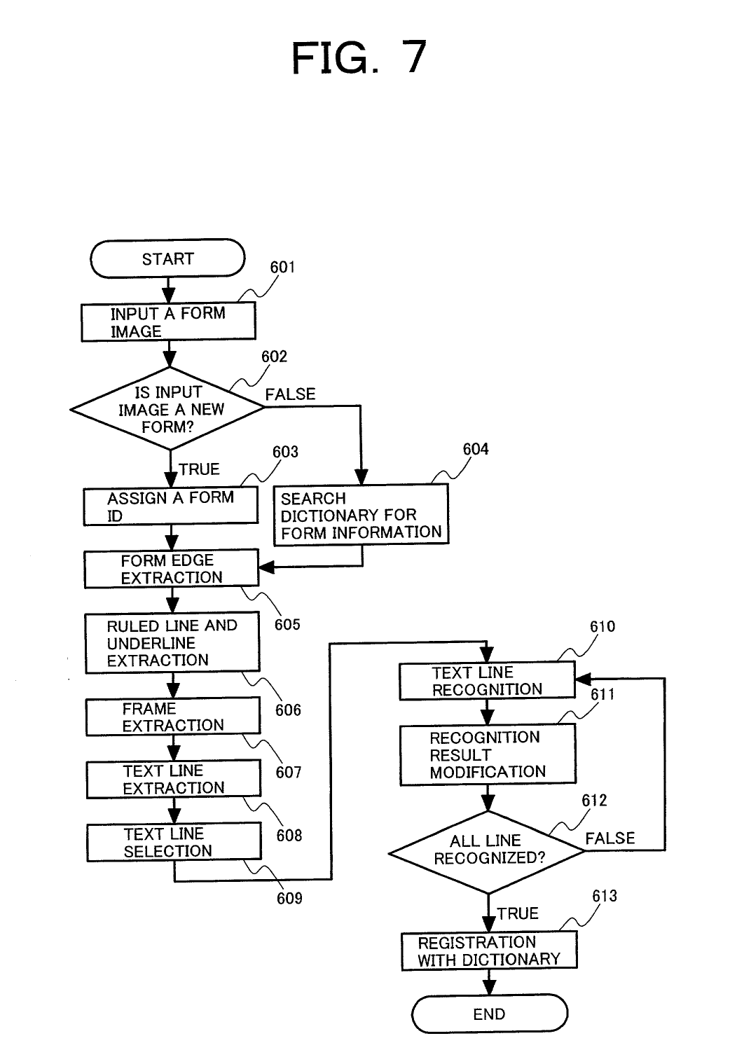

FIG. 7 is a flow chart for illustrating the update processing procedure of the form identification dictionary executed in the work center. This dictionary update processing procedure will be elucidated below. This processing is executed by the manager of history of dictionary changes 115, newly adds the form identification information to the form identification dictionary or changes the form identification information, on the basis of the analysis results of the failure cause of the form identification. In the following description, it is presumed, only by way of example, that the character strings are utilized as the form identification information registered in the form identification dictionary.

(1) At first, the form image belonging to the form type to be updated is inputted. It is then decided whether or not the form type of the inputted form image is new one. When it is decided to be a new type, an unused form identifier (ID) is assigned to the form of the new type to be newly registered (steps 601 to 603).

(2) By contrast, when it is decided in step 602 that the inputted form image is that of the form which has already been registered in the master of form identification dictionary 112 and thus need not be newly registered, its information is extracted from the master of form identification dictionary 112 (step 604).

(3) After completion of the processing in 603 or 604, processing for extracting form edges, ruled lines/underlines, frames and text lines from the inputted form image is executed. Subsequently, the text line(s) to be registered in the form identification dictionary is selected from those extracted text lines. This selection may be commanded by an operator of the manager of history of dictionary changes 115. Alternatively, all the text lines as extracted may be selected (steps 605 to 609).

(4) In succession, processing for the text line recognition of the text line(s) selected in step 609 is executed to obtain the text line recognition result. If error(s) is found in the obtained text line recognition result, it is corrected by the operator (steps 610, 611).

(5) Subsequently, it is decided whether or not any of the text lines selected in step 609 remains to undergo the text line recognition processing. If some text line(s) remains to be recognized, the recognition processing in step 610 is resumed to be executed in succession. By contrast, when it is decided that the recognition processing for all the text lines as selected has been completed, the obtained text line recognition result is then registered in the master of form identification dictionary 112 under the control of the manager of form identification dictionary 111. Also, the update information is stored in the history of dictionary changes 116, and then the processing comes to an end (steps 612, 613).

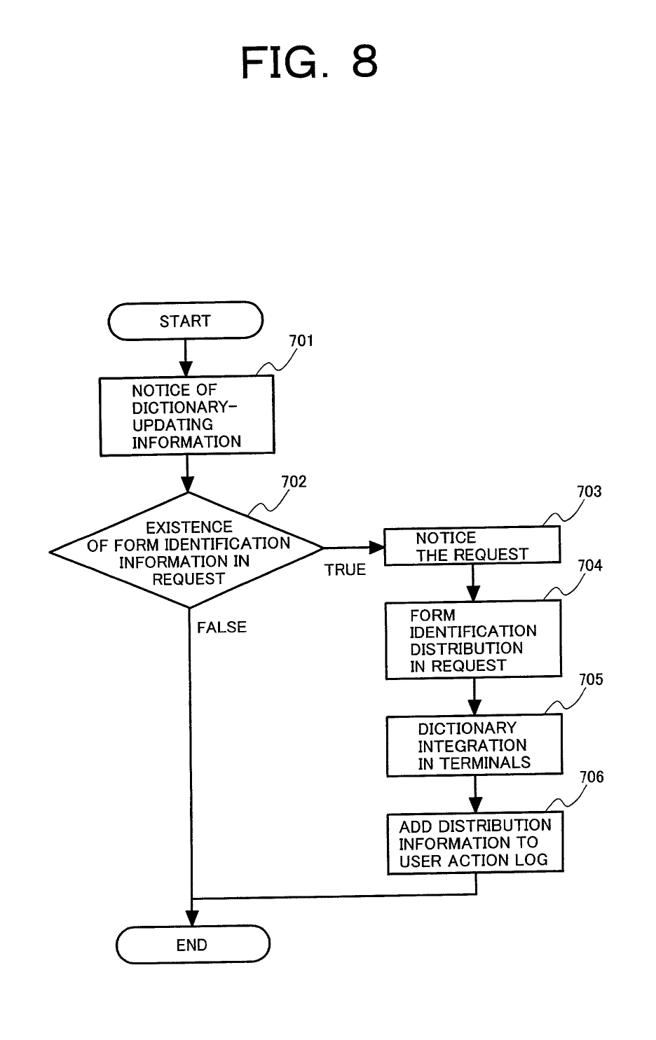

FIG. 8 is a flow chart for illustrating a processing procedure for the form identification information distribution executed between the work center and the form processing terminal(s), which will be elucidated below. This processing is carried out between the manager of history of dictionary changes 115 in the work center and the form processing terminals 121 in the individual financial institutions 202.

(1) In the first place, the manager of history of dictionary changes 115 in the work center informs the individual financial institutions of the dictionary update information via the network (step 701). As the informing method, there may be adopted the electronic mail. Alternatively, the Web server may be held active in the manager of history of dictionary changes 115 so that the financial institution(s) can make access thereto. Of course, any other method appropriate to this end may be resorted to.

(2) The financial institution checks whether or not any desired form identification information for use exists among the update information as informed. When no desired form identification information is found, any further processing is not performed. Then, the processing comes to an end (step 702).

(3) On the other hand, when the desired form identification information is found in step 702, the form processing terminal informs the manager of history of dictionary changes 115 of a request for use. Of course, this procedure can be spared when such a contract is made between the financial institution and the work center that any update information be always distributed to the financial institution (step 703).

(4) Upon reception of the request for distribution, the manager of history of dictionary changes 115 distributes via the network the form identification information which the financial institution desires to use (step 704).

(5) The form processing terminal received the form identification information in step 704 then merges the information, which is contained at that time point in the form identification dictionary 122 of the form processing terminal itself, and the distributed form identification information to thereby update the form identification dictionary thereof. Thus, a new form identification dictionary is created (step 705).

(6) Finally, the manager of history of dictionary changes 115 which distributes the form identification information to the form processing terminal records the distribution history in the user action log 118. Then, the processing comes to an end (step 706).

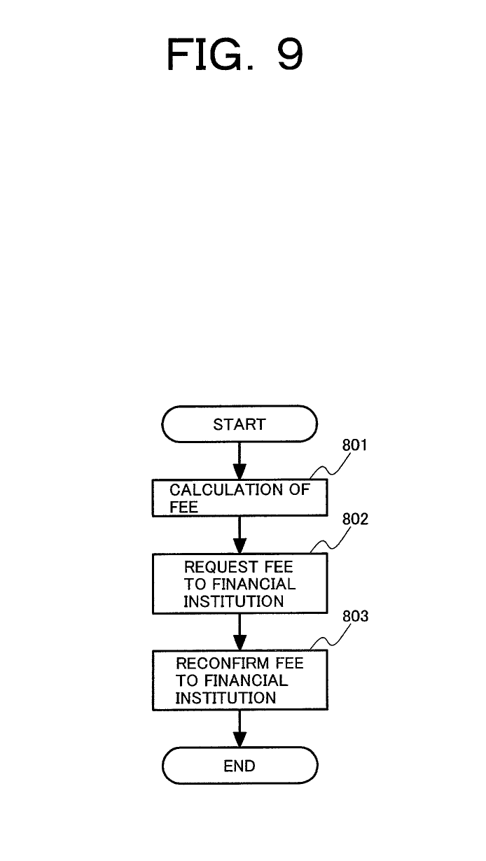

FIG. 9 is a flow chart for illustrating a processing procedure for charging the system fee to the financial institution and confirming the payment, executed in the manager of system fee 117 of the work center. This processing procedure will be described below in detail.

(1) At first, the manager of system fee 117 calculates the system fee of each of the financial institution by referencing the user action log 118 (step 801).

(2) Subsequently, the amount of system fee is messaged to the respective financial institution. Then, the manager of system fee 117 checks whether or not the system fee has duly been paid by the financial institution, the result of which is entered in the user action log 118. Then, the processing comes to an end (steps 802 and 803).

In conjunction with the processing procedure described above, it is apparent that the amount of system fee can be determined in dependence on the contract made between the owner of the work center and the financial institution. For example, the amount of system fee may be determined by previously fixing the unit price (piece rate) per form identification information under contract and multiplying the unit price by the number of the form identification information used by the financial institution during a prescribed period (independently of the number of the form processing terminals installed at the financial institution), or alternatively by multiplying the unit price by the total number of the form identification information used by a plurality of the form processing terminals installed at the financial institution, or alternatively by adding to the amount determined as mentioned above a basic fee per predetermined period, e.g. per month. Furthermore, the amount of system fee for the financial institution which has provided new form information may be made charge-free or charged at a discount unit price. On the other hand, for the other financial institution used the above form information, the amount of system fee may be calculated on the basis of the ordinary unit price.

The payment of the system fee by the financial institution may be made to the deposit account of the owner of the work center or by check or by any other appropriate methods.

The embodiment of the present invention described in the foregoing is directed to the form processing system in which upon occurrence of form identification failure in the form processing executed by the form processing terminal, the image information of the form failed to be identified is sent to the work center. However, according to another embodiment of the invention, the form processing system may be so arranged that when the form fails to be identified in the form processing executed at the form processing terminal, information having significance to the identification-failed form is sent to the work center together with the image information of that form for the purpose of aiding the update processing of the form identification dictionary. In the following, this embodiment of the invention will be described. In this conjunction, it is noted that as the information for supporting the creation of the form identification information, there are available two information which characterize the form type. They are (1) the position information and (2) the character string information. The following description will be made separately in conjunction with the respective cases.

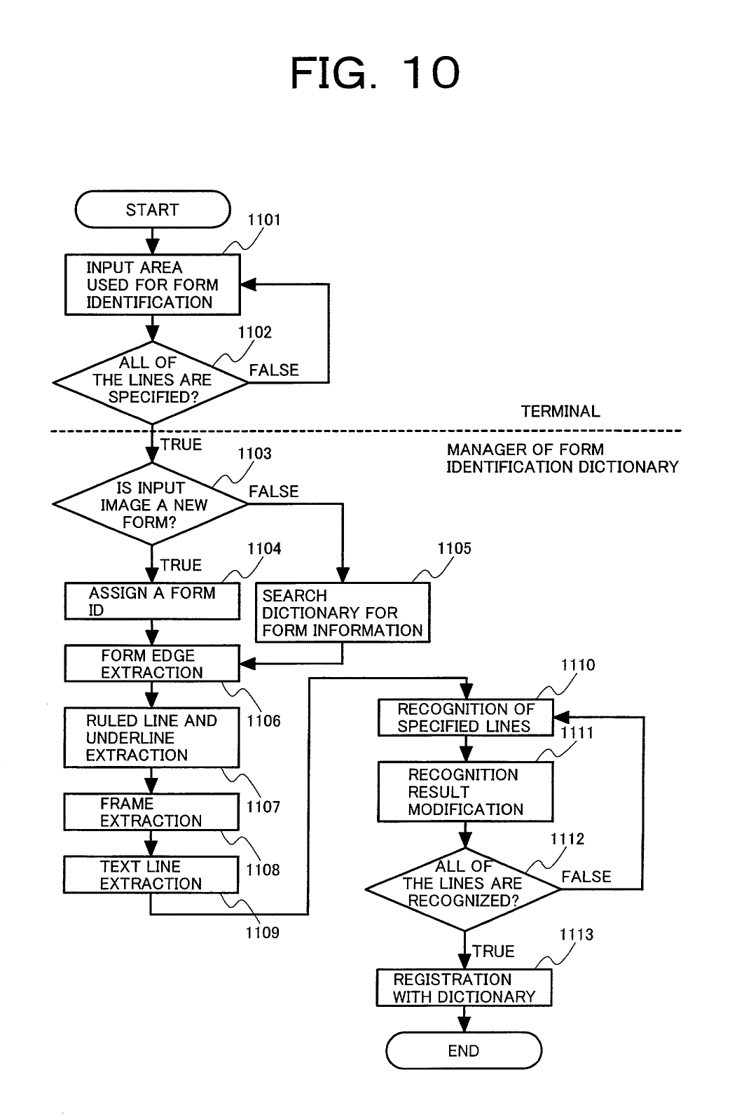

FIG. 10 is a flow chart for illustrating a processing procedure for updating the form identification dictionary in case where the creation supporting information of the form identification dictionary is the text line position information.

(1) When the form processing terminal in the financial institution fails the form identification processing, it inputs the position information of the text line which characterizes the form type. The text line position information may be inputted directly from a keyboard in terms of the coordinate values. Alternatively, the corresponding form image may be displayed on the screen of the terminal so that the operator can click the text line with a mouse to thereby input the coordinate values thereof. Further, as the position information of the text line, the top-left and bottom-right points of rectangule covering the text line entry area may be employed. Alternatively, simply the coordinates of a given point within the text line entry area may be used. In the following description, it is presumed that the coordinates of a given point within the text line entry area is employed as the position information of the text line (step 1101).

(2) It is checked whether or not the text line to be inputted remains. If so, the processing in step 1101 is executed repeatedly, to thereby execute the processing for all the text lines, and then the information of the form image and the position information of the text lines are sent to the work center. The processing up to this step are executed by the form processing terminal in the financial institution. The succeeding processing is executed by the manager of form identification dictionary 111 in the work center (step 1102).

(3) It is decided whether or not the type of the form which is sent from the form processing terminal is new one. When it is new one, an unused form identifier (ID) is assigned to the form of the new type to be newly registered (steps 1103, 1104).

(4) By contrast, when it is decided in step 1103 that the form type has already been registered in the master of form identification dictionary and thus need not be newly registered, then its information is extracted from the master of form identification dictionary 112 (step 1105).

(5) After completion of the processing in step 1104 or 1105, processing for extracting form edge lines, ruled lines/underlines, frames, and text lines from the inputted form image is executed. Subsequently, the text line candidate which includes the point coordinates inputted by the form processing terminal and for which the text line recognition processing has not been executed yet is selected from the extracted text lines, and then the text line recognition processing is carried out for the candidate as selected. Through this processing, there can be acquired the coordinates of the rectangular area in which the character strings recognized by this processing and the text line thereof are described (steps 1106 to 1110).

(6) When error(s) is found in the text line recognition result as acquired in the step 1110, it is corrected by the operator. Then, it is decided whether or not all the candidates for the text line recognition including the point coordinates inputted through the form processing terminal have been recognized. If any candidates remain to be recognized, then the processing in step 1110 is executed repeatedly (steps 1111, 1112).

(7) By contrast, when it is decided in step 1112 that the recognition of all the text lines has been completed, the text line recognition processing result and the form identification information such as the size of the form, ruled lines/underlines, frames, etc. are then registered in the master of form identification dictionary 112 under the control of the manager of form identification dictionary 111. Further, the update information is stored in the history of dictionary changes 116, and then the processing comes to an end (step 1113).

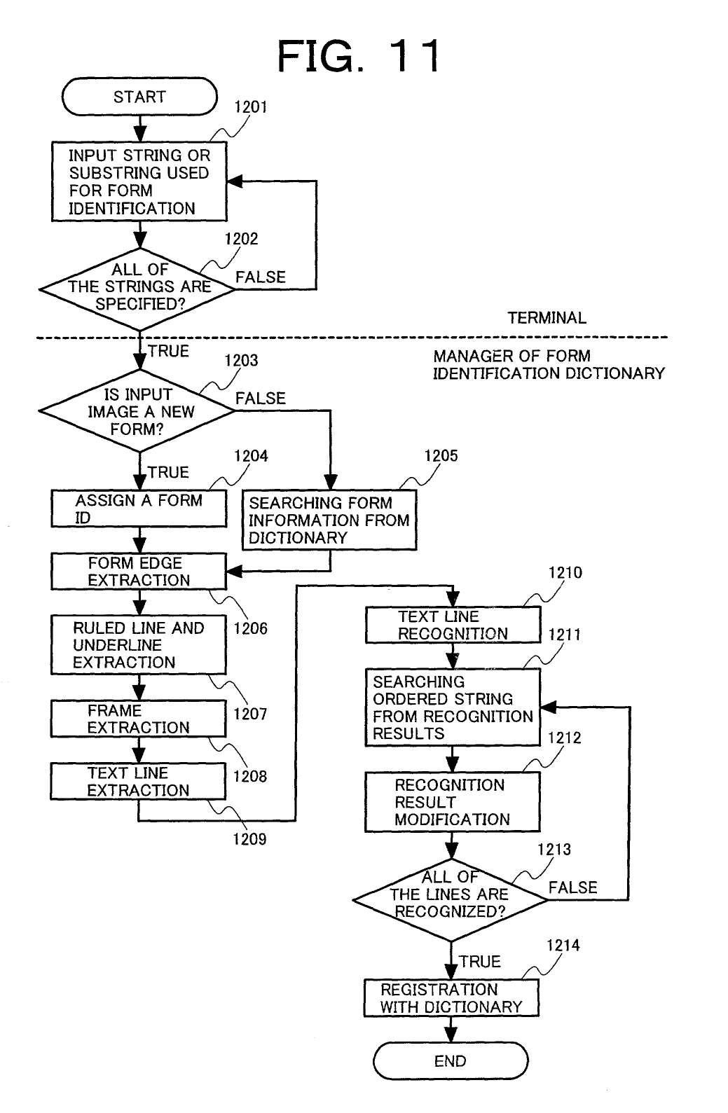

FIG. 11 is a flow chart for illustrating a processing procedure for updating the form identification dictionary in case where the creation supporting information of the form identification dictionary is the character string information.

(1) When the form processing terminal in the financial institution in the form processing system fails the form identification, it inputs the character string or character substring which characterizes the form type. The character string information may be inputted from a keyboard (step 1201).

(2) It is decided whether or not the character string to be inputted remains. If so, the processing in step 1201 is executed repeatedly, to thereby execute the processing for all the character strings, and then the image information of the form and the information of the character string(s) are sent to the work center. The processing up to this step are executed by the form processing terminal in the financial institution. The succeeding processing is executed by the manager of form identification dictionary 111 in the work center (step 1202).

(3) It is decided whether or not the type of the form which is sent from the form processing terminal is new one. When it is new one, an unused form identifier (ID) is assigned to the form of the new type to be newly registered (steps 1203, 1204).

(4) By contrast, when it is decided in step 1103 that the form type has already been registered in the master of form identification dictionary and thus need not be newly registered, its information is extracted from the master of form identification dictionary 112 (step 1205).

(5) After completion of the processing in step 1204 or 1205, processing for extracting from edge lines, ruled lines/underlines, frames and text lines from the inputted form image is executed. Subsequently, the text line candidates as extracted is recognized. Through this processing, there can be acquired the coordinates of the rectangular area in which the recognized character strings and the text line thereof are described (steps 1206 to 1210).

(6) The recognition result of the text line containing the character string inputted through the form processing terminal is searched. When error(s) is found in the text line recognition result as acquired in step 1210, it is corrected. Then, it is decided whether or not all the character strings inputted through the form processing terminal have been recognized. If any character strings remain to be recognized, then the processing succeeding to the search processing for the text line recognition result described above is executed repeatedly (steps 1211 to 1213).

(7) By contrast, when it is decided in step 1213 that the recognition processing of all the text lines has been completed, the text line recognition processing result and the form identification information such as the size of the form, ruled lines/underlines, frames, etc. are then registered in the master of form identification dictionary 112 under the control of the manager of form identification dictionary 111. Further, the update information is stored in the history of dictionary changes 116, and then the processing comes to an end (step 1113).

Incidentally, when the form processing terminal has sent the form image affixed with the creation supporting information of the form identification dictionary, this event may be recorded in the user action log of the manager of system fee, as described above. In that case, such service as discounting of the system fee by a proportion corresponding to the number of times the creation supporting information of the form identification dictionary has been furnished may be presented.

Furthermore, according to the embodiments of the present invention described previously, even in case the form images are difficult to acquire in advance, the form identification dictionary can progressively be updated in the course of operation of the form processing system. Accordingly, there can be realized the form identification function which is capable of handling a large number of form types.

Furthermore, according to the embodiments of the present invention described in the foregoing, upon occurrence of failure in the form identification, the information which characterizes the form such as the title of the form and the subscriber name can be affixed to the image of the identification-failed form to be sent to the manager of form identification dictionary. By virtue of this feature, the form identification dictionary can be updated with enhanced efficiency.

In addition, according to the embodiments of the present invention described in the foregoing, the history of uses of the form processing system can be recorded in the user action log. Owing to this feature, accounting for the distribution of the information for identification of the form type can automatically be carried out.

As can now be understood from the foregoing description, according to the present invention, it is possible to update the form identification information progressively and to cope with several tens of thousands of form types. As a result, it is possible to create the form identification dictionary with enhanced efficiency. Besides, the fee for the form identification information distribution service can be charged conveniently.

Many modifications and variations of the present invention are possible in the light of the above techniques. It is therefore to be understood that within the scope of the appended claims, the invention may be practiced otherwise than as specifically described.

What is claimed is:

1. A form processing system comprising:
a management system of form identification dictionary including a manager of form identification dictionary for creating and managing a form identification dictionary for identifying a type of a form; and
a plurality of form processing terminals, each of said form processing terminals having a form identification dictionary for identifying the type of the form, and identifying the form to process the form, wherein
said management system of form identification dictionary and said plurality of form processing terminals are interconnected via a network;
said form processing terminal, upon occurrence of failure in identification of the form based on said form identification dictionary of said form processing terminal itself, transmits image information of the form to said management system of form identification dictionary; and
said management system of form identification dictionary, when said image information of the form transmitted from said form processing terminal has not yet been registered in said form identification dictionary of said manager of form identification dictionary, creates information for identifying the type of the form, stores the created information in said form identification dictionary of said manager of form identification dictionary, and transmits the created information to said form processing terminal.

2. A form processing system comprising:
a management system of form identification dictionary including a manager of form identification dictionary for creating and managing a form identification dictionary for identifying a type of a form; and
a plurality of form processing terminals, each of said form processing terminals having a form identification dictionary for identifying the type of the form, and identifying the form to process the form, wherein
said management system of form identification dictionary and said plurality of form processing terminals are interconnected via a network;
said form processing terminal, upon occurrence of failure in identification of the form based on said form identification dictionary of said form processing terminal itself, transmits image information of the form to said management system of form identification dictionary; and
said management system of form identification dictionary, when said image information of the form transmitted from said form processing terminal has been registered in said form identification dictionary of said manager of form identification dictionary, reads out information for identifying the type of the form from said form identification dictionary in said manager of form identification dictionary, and transmits the read-out information to said form processing terminal.

3. A form processing system according to claim 1, wherein said form processing terminal, upon occurrence of failure in the identification of the form based on said form identification dictionary of said form processing terminal itself, transmits to said management system of form identification dictionary the image information of the form together with information for supporting a work of creating the form identification dictionary.

4. A form processing system according to claim 1, wherein
said management system of form identification dictionary, when said form identification dictionary of said manager of form identification dictionary is updated, informs said plurality of form processing terminals of form identification dictionary update information; and
said management system of form identification dictionary, upon reception of a request for use from at least one of said form processing terminals, distributes the form identification information as requested to said at least one of said from processing terminals.

5. A form processing system according to claim 4, wherein
said management system of form identification dictionary comprises a manager of system fee; and
said manager of system fee manages a use of the distribution of said form identification information every form processing terminal, and performs charging to said form processing terminals.

6. A management system of form identification dictionary, wherein
said management system of form identification dictionary is interconnected to a plurality of form processing terminals via a network, each of said form processing terminals including a form identification dictionary for identifying a type of a form, and identifies the form to process the form;
said management system of form identification dictionary comprises a manager of form identification dictionary which creates and manages a form identification dictionary for identifying the type of the form; and
when said form processing terminal fails to identify the form and image information of the form transmitted from said form processing terminal has not yet registered in said form identification dictionary of said manager of form identification dictionary, said management system of form identification dictionary creates information for identifying the type of the form, stores the created information in said form identification dictionary of said manager of form identification dictionary, and transmits the created information to said form processing terminal.

7. A management system of form identification dictionary, wherein
said management system of form identification dictionary is interconnected to a plurality of form processing terminals via a network, each of said form processing terminals including a form identification dictionary for identifying a type of a form, and identifies the form to process the form;
said management system of form identification dictionary comprises a manager of form identification dictionary which creates and manages a form identification dictionary for identifying the type of the form; and
when said form processing terminal fails to identify the form and image information of the form transmitted from said form processing terminal has registered in said form identification dictionary of said manager of form identification dictionary, said management system of form identification dictionary reads out information for identifying the type of the form from said form identification dictionary in said manager of form identification dictionary, and transmits the read-out information to said form processing terminal.

8. A management system of form identification dictionary according to claim 6, wherein
when said form identification dictionary in said manager of form identification dictionary is updated, said management system of form identification dictionary informs said plurality of form processing terminals of form identification dictionary update information; and
said management system of form identification dictionary, upon reception of a request for use from at least one of said form processing terminals, distributes the form identification information as requested to said at least one of said from processing terminals.

9. A management system of form identification dictionary according to claim 8, comprising a manager of system fee, wherein
said manager of system fee manages a use of the distribution of said form identification information every form processing terminal, and performs charging to said form processing terminals.

10. A form processing terminal, wherein
said form processing terminal is interconnected via a network to a management system of form identification dictionary which includes a manager of form identification dictionary, said manager of form identification dictionary creating and managing a form identification dictionary for identifying a type of a form;
said form processing terminal includes a form identification dictionary for identifying the type of the form, and identifies the form to process the form; and
said form processing terminal, upon occurrence of failure in identification of the form based on said form identification dictionary of said form processing terminal itself, transmits image information of the form to said management system of form identification dictionary to receive form identification information from said management system of form identification dictionary.

11. A form processing terminal according to claim 10, wherein said form processing terminal, upon occurrence of failure in the identification of the form based on said form identification dictionary of said form processing terminal itself, transmits to said management system of form identification dictionary the image information of the form together with information for supporting a work of creating the form identification dictionary.

12. A form processing terminal according to claim 10, wherein
when said form identification dictionary in said manager of form identification dictionary in said management system of form identification dictionary is updated, said form processing terminal receives form identification dictionary update information informed from said management system of form identification dictionary, transmits a request for using necessary form identification information to said management system of form identification dictionary, and receives the form identification information as requested from said management system of form identification dictionary.

13. A method of distributing form identification information from a management system of form identification dictionary to a plurality of a form processing terminals, wherein
said management system of form identification dictionary includes a manager of form identification dictionary for creating and managing a form identification dictionary for identifying a type of a form;
each of said plurality of form processing terminals has a form identification dictionary for identifying the type of the form, and identifies the form to process the form, said management system of form identification dictionary and said plurality of form processing terminals being interconnected via a network;
said form processing terminal, upon occurrence of failure in identification of the form based on said form identification dictionary of said form processing terminal itself, transmits image information of the form to said management system of form identification dictionary; and
said management system of form identification dictionary, when said image information of the form transmitted from said form processing terminal has not yet been registered in said form identification dictionary of said manager of form identification dictionary, creates information for identifying the type of the form, stores the created information in said form identification dictionary of said manager of form identification dictionary, and transmits the created information to said form processing terminal.

14. A method of distributing form identification information from a management system of form identification dictionary to a plurality of a form processing terminals, wherein
said management system of form identification dictionary includes a manager of form identification dictionary which creates and manages a form identification dictionary for identifying a type of a form;
each of said plurality of form processing terminals has a form identification dictionary for identifying the type of the form, and identifies the form to process the form, said management system of form identification dictionary and said plurality of form processing terminals being interconnected via a network;
said form processing terminal, upon occurrence of failure in identification of the form based on said form identification dictionary of said form processing terminal itself, transmits image information of the form to said management system of form identification dictionary; and
said management system of form identification dictionary, when said image information of the form transmitted from said form processing terminal has been registered in said form identification dictionary of said manager of form identification dictionary, reads out information for identifying the type of the form from said form identification dictionary in said manager of form identification dictionary, and transmits the read-out information to said form processing terminal.

15. A method according to claim 13, wherein said form processing terminal, upon occurrence of failure in the identification of the form based on said form identification dictionary of said form processing terminal itself, transmits to said management system of form identification dictionary the image information of the form together with information for supporting a work of creating the form identification dictionary.

16. A method according to claim 13, wherein
said management system of form identification dictionary, when said form identification dictionary in said manager of form identification dictionary is updated, informs said plurality of form processing terminals of form identification dictionary update information; and
said management system of form identification dictionary, upon reception of a request for use from at least one of said form processing terminals, distributes the form identification information as requested to said at least one of said from processing terminals.

17. A method according to claim 16, wherein
said management system of form identification dictionary manages a use of the distribution of said form identification information every form processing terminal, and performs charging to said form processing terminals.
